(19) United States
(12) Patent Application Publication
(10) Pub. No.: US 2010/0140096 A1
(43) Pub. Date: Jun. 10, 2010

(54) ELECTRODE FOR CAPACITIVE DEIONIZATION, CAPACITIVE DEIONIZATION DEVICE AND ELECTRIC DOUBLE LAYER CAPACITOR INCLUDING THE ELECTRODE

(75) Inventors: Ho-jung YANG, Suwon-si (KR); Hyo-rang KANG, Anyang-si (KR); Tae-won SONG, Yongin-si (KR); Chang-hyun KIM, Seoul (KR)

Correspondence Address: CANTOR COLBURN, LLP, 20 Church Street, 22nd Floor, Hartford, CT, 06103, US

(73) Assignee: Samsung Electronics Co., Ltd., Suwon-si (KR)

(21) Appl. No.: 12/533,674

(22) Filed: Jul. 31, 2009

(30) Foreign Application Priority Data
Dec. 5, 2008 (KR) 10-2008-0123154

(51) Int. Cl. C02F 1/461

(52) U.S. Cl. 204/672; 204/660

(57) ABSTRACT

An electrode for capacitive deionization, the electrode including an active material having an oxygen/carbon (“O/C”) atomic ratio between about 0.1 and about 1 and a specific surface area between about 500 square meters per gram (“m²/g”) and about 3,000 m²/g.

### CROSS-REFERENCE TO RELATED APPLICATIONS

This application claims priority to Korean Patent Application No. 10-2008-0123154, filed on Dec. 5, 2008, and all the benefits accruing therefrom under 35 U.S.C. §119, the contents of which in its entirety are herein incorporated by reference.

### BACKGROUND

1. Field

One or more embodiments relate to an electrode for capacitive deionization, a capacitive deionization device and an electric double layer capacitor including the electrode.

2. Description of the Related Art

Capacitive deionization (“CDI”) is a technology for removing an ionic material from a medium by absorbing the ionic material into a surface of a carbon electrode having nano-sized pores by applying a first voltage to the carbon electrode. To regenerate the carbon electrode, a second voltage opposite in polarity to the first voltage is applied to the carbon electrode, so as to remove the absorbed ionic material, and the ionic material is discharged with water. CDI may operate without chemicals to regenerate the carbon electrode and may operate without an ion exchange resin, a filter or a membrane. Also, CDI may improve capacitance of the medium, such as water, without discharging hardness components, such as Ca²⁺ or Mg²⁺, or harmful ions, such as Cl⁻.

In CDI, when a direct current (“DC”) voltage having a low potential difference versus the medium is applied to a carbon electrode while a medium, i.e. an electrolyte containing dissolved ions, flows through a flow path and contacts the carbon electrode, anions are absorbed and concentrated in an anode, and cations are absorbed and concentrated in a cathode. Accordingly, when application of the DC voltage is stopped, the concentrated anions and cations are desorbed from the anode and cathode, each of which may be a carbon electrode.

The carbon electrode desirably has a low electrical resistance and a large specific surface area, and thus the carbon electrode is manufactured by binding an activated carbon with polytetrafluoroethylene (“PTFE”), or the carbon electrode is manufactured by carbonizing a resorcinol formaldehyde resin and then performing a complicated drying process, thereby obtaining a carbon electrode having a plate-like shape.

Commercial electrodes for CDI are usually in the form of a sheet and are manufactured by binding an activated carbon with PTFE. The activated carbon has a large specific surface area and numerous pores, and thus has high processing capacity when the activated carbon is used as an active material for a CDI electrode. However, when the activated carbon is used as an active material in a CDI electrode, a processing capacity may remarkably deteriorate after repeated charging and discharging. It is therefore desirable to have an electrode having less deterioration in processing capacity after repeated charging and discharging cycles.

### SUMMARY

One or more embodiments include an electrode for capacitive deionization including an active material having an oxygen/carbon (“O/C”) atomic ratio between about 0.1 and about 1 and a specific surface area between about 500 square meters per gram (“m²/g”) and about 3,000 m²/g.

One or more embodiments include a capacitive deionization device including the electrode.

One or more embodiments include an electric double layer capacitor including the electrode.

To achieve the above and/or other aspects, features or advantages, one or more embodiments may include an electrode for capacitive deionization, the electrode including an active material having an O/C atomic ratio between about 0.1 and about 1 and a specific surface area between about 500 m²/g and about 3,000 m²/g.

The active material may include an oxygen containing functional group, wherein the oxygen containing functional group may include a group selected from the group consisting of a phenol group, a phenoxy group, a lactone group, a carboxyl group, a carbonate group, a carbonyl group and a combination comprising at least one of the foregoing groups.

The active material may include carbon black.

The carbon black may include ketjen black.

The amount of the active material may be between about 70 weight percent (“wt %”) and about 98 wt % of a total weight of the electrode.

The electrode may further include CaSO₄ formed on the electrode.

To achieve the above and/or other aspects, advantages or features, one or more embodiments may include a capacitive deionization device including the foregoing electrode.

To achieve the above and/or other aspects, advantages or features, one or more embodiments may include an electrode for an electric double layer capacitor, the electrode including an active material having an O/C atomic ratio between about 0.1 and about 1 and a specific surface area between about 500 m²/g and about 3,000 m²/g.

To achieve the above and/or other aspects, advantages or features, one or more embodiments may include an electric double layer capacitor including the foregoing electrode.

In an embodiment, the electrode may further include calcium or magnesium.

Also disclosed is a water softener, including an electrode including an active material having an oxygen to carbon atomic ratio between about 0.1 and about 1 and a specific surface area between about 500 square meters per gram and about 3,000 square meters per gram.

In an embodiment, the water softener may include a serpentine type flow path. In another embodiment, the water softener may include a flow-through type flow path.

### BRIEF DESCRIPTION OF THE DRAWINGS

These and/or other aspects will become more apparent and more readily appreciated from the following description of the embodiments, taken in conjunction with the accompanying drawings in which:

FIG. 1 is a cross-sectional view schematically illustrating an exemplary embodiment of a capacitive deionization device including an electrode;

FIG. 2 is a perspective view schematically illustrating another exemplary embodiment of a capacitive deionization device including an electrode;

FIG. 3 is a cross-sectional view schematically illustrating an exemplary embodiment of an electric double layer capacitor including an electrode;

FIG. 4 is a graph showing ionic conductivity of an outflow electrolyte with respect to a processing time while operating an exemplary embodiment of a cell comprising an activated carbon as an active material, wherein definitions of a charge area and a discharge area are shown;

FIG. 5 is a graph showing charging efficiency with respect to charge cycle when hard water is softened by an exemplary embodiment of a unit cell including an exemplary embodiment of an electrode and unit cells including commercially available electrodes;

FIG. 6 is a graph showing discharging efficiency with respect to discharge cycle when hard water is softened by an exemplary embodiment of a unit cell including an exemplary embodiment of an electrode and unit cells including commercially available electrodes;

FIG. 7 is a graph showing scale production ratio with respect to charge and discharge cycle, when hard water is softened by an exemplary embodiment of a unit cell including an exemplary embodiment of an electrode and unit cells including commercially available electrodes;

FIGS. 8A and 8B are scanning electron microscope (“SEM”) photographic images of an exemplary embodiment of an electrode respectively taken before and after being used to soften hard water; and

FIGS. 9A and 9B are SEM photographic images of a commercially available electrode respectively taken before and after being used to soften hard water.

### DETAILED DESCRIPTION

Aspects, advantages and features of exemplary embodiments of the invention and methods of accomplishing the same may be understood more readily by reference to the following detailed description of embodiments and the accompanying drawings. The exemplary embodiments of the invention may, however, may be embodied in many different forms and should not be construed as being limited to the embodiments set forth herein. Rather, these embodiments are provided so that this disclosure will be thorough and complete and will fully convey the concept of the invention to those skilled in the art, and the exemplary embodiments of the invention will only be defined by the appended claims. Like reference numerals refer to like elements throughout the specification.

It will be understood that when an element or layer is referred to as being “on” or “connected to” another element or layer, the element or layer may be directly on or connected to another element or layer or intervening elements or layers. In contrast, when an element is referred to as being “directly on” or “directly connected to” another element or layer, there are no intervening elements or layers present. As used herein, the term “and/or” includes any and all combinations of one or more of the associated listed items.

It will be understood that, although the terms first, second, third, etc., may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the exemplary embodiments of the invention.

Spatially relative terms, such as “below,” “lower,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “lower” relative to other elements or features would then be oriented “above” relative to the other elements or features. Thus, the exemplary term “below” may encompass both an orientation of above and below. The device may be otherwise oriented (rotated 90 degrees or at other orientations) and the spatially relative descriptors used herein interpreted accordingly.

As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Embodiments of the invention are described herein with reference to cross-section illustrations that are schematic illustrations of idealized embodiments (and intermediate structures) of the invention. As such, variations from the shapes of the illustrations as a result, for example, of manufacturing techniques and/or tolerances, are to be expected. Thus, embodiments of the invention should not be construed as limited to the particular shapes of regions illustrated herein but are to include deviations in shapes that result, for example, from manufacturing.

For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of the invention.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

All methods described herein may be performed in a suitable order unless otherwise indicated herein or otherwise clearly contradicted by context. The use of any and all examples, or exemplary language (e.g., “such as”), is intended merely to better illustrate the invention and does not pose a limitation on the scope of the invention unless otherwise claimed. No language in the specification should be construed as indicating any non-claimed element as essential to the practice of the invention as used herein.

Reference will now be made in detail to embodiments, examples of which are illustrated in the accompanying drawings.

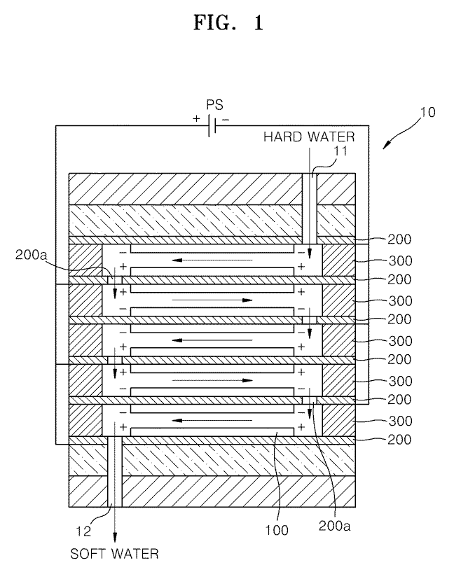

An electrode 100 of FIGS. 1 through 3, according to an embodiment, includes an active material layer.

The active material layer includes an active material and a binder, and may further include a conductive agent. The active material may be formed separately, may be self-supporting or may be formed on a support (not shown).

The support may include a carbon paper, a carbon felt, a carbon cloth, a metal foam, a metal paper, a metal felt, a metal cloth, or the like or a combination comprising at least one of the foregoing.

The active material has an oxygen to carbon (“O/C”) atomic ratio between about 0.1 and about 1, specifically between about 0.2 and about 0.8, more specifically between about 0.4 and about 0.6 and a specific surface area between about 500 square meters per gram (“m²/g”) and about 3,000 m²/g, specifically between about 1,000 m²/g and about 2,000 m²/g, more specifically about 1,500 m²/g. As used herein, an oxygen to carbon atomic ratio, or O/C atomic ratio, denotes a ratio of the total amount of oxygen and carbon in the active material, respectively.

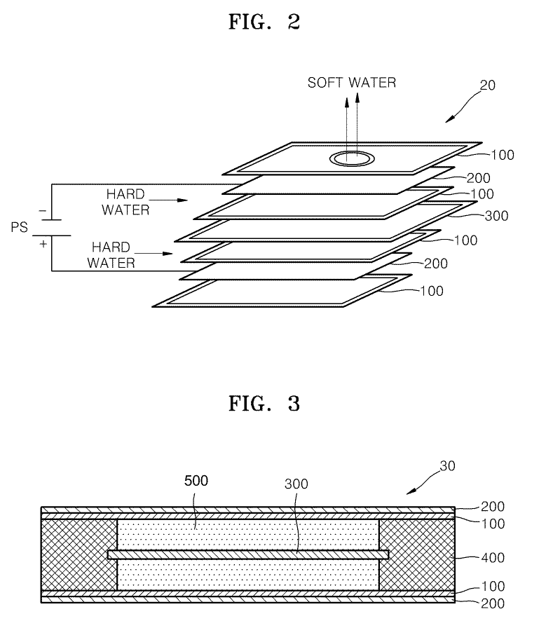

When the O/C atomic ratio and the specific surface area of the active material are within the foregoing ranges, durability of a capacitive deionization device, such as a first capacitive deionization device 10 of FIG. 1 or a second capacitive deionization device 20 of FIG. 2, each of which include the electrode 100, may be improved, as described in further detail below.

The active material may include a functional group including oxygen. The functional group may include a group selected from the group consisting of a phenol group, a phenoxy group, a lactone group, a carboxyl group, a carbonate group, a carbonyl group, or the like or a combination comprising at least one of the foregoing groups.

The active material may include carbon black. The carbon black may include, for example, ketjen black. However, the active material is not limited thereto, and any active material having an O/C atomic ratio between about 0.1 and about 1, specifically between about 0.2 and about 0.8, more specifically between about 0.4 and about 0.6 and a specific surface area between about 500 m²/g and about 3,000 m²/g specifically between about 1,000 m²/g and about 2,000 m²/g, more specifically about 1,500 m²/g may be used.

The amount of the active material may be between about 70 weight percent (“wt %”) and about 98 wt %, specifically between about 80 weight percent (“wt %”) and about 90 wt %, more specifically about 85 wt % of the total weight of any given electrode of the electrodes 100. In an embodiment, the amount of the active material may be between about 70 weight percent (“wt %”) and about 98 wt %, specifically between about 80 weight percent (“wt %”) and about 90 wt %, more specifically about 85 wt % of the total weight of the electrodes. When the amount of the active material is more than about 70 wt %, capacity of the electrode 100 may improve, and when the amount of the active material is less than about 98 wt %, coherence between active materials improves, thereby increasing electrical conductivity and electrode stability.

The binder may include styrene butadiene rubber (“SBR”), carboxymethylcellulose (“CMC”), polytetrafluoroethlyene (“PTFE”), or the like or a combination comprising at least one of the foregoing.

The conductive material may include carbon black, vapour growth carbon fiber (“VGCF”), graphite, or the like or a combination comprising at least one of the foregoing.

FIG. 1 is a cross-sectional view schematically illustrating an exemplary embodiment of a first capacitive deionization device 10 including an electrode 100. The first capacitive deionization device 10 of FIG. 1 may be a serpentine type water softener.

In the accompanying drawings, like reference numerals refer to the like elements throughout.

Referring to FIG. 1, the first capacitive deionization device 10 includes the electrode 100, a current collector 200, and a separator 300. The electrode 100 is disposed on one or both sides of the current collector 200, and such combinations of the electrode 100 and the current collector 200 may be stacked in a plurality of layers, wherein the separator 300 is disposed between the combinations, so as to form a stack. A hole 200a is disposed in a portion of either end or both ends of the current collector 200 in a portion of the current collector 200 where the electrode 100 is not disposed. Hard water flows into the stack via an inlet 11 and may flow between electrodes in a serpentine type path, or a zigzag path, which includes flow through the hole 200a. While the hard water passes through the stack, the hard water is softened and changed into soft water, and the soft water is externally discharged via an outlet 12. Externally discharged soft water may be outflow electrolyte.

A power supply PS is electrically connected to the current collectors. Thus the current collectors are in an electrical path to supply an electric charge to the electrodes during charging, i.e. while softening the hard water, and to discharge the electric charge accumulated in the electrodes during discharging, i.e. while regenerating the electrodes. The current collector 200 may be a carbon plate, a carbon paper, a metal plate, a metal mesh, a metal foam, or the like or a combination comprising at least one of the foregoing, and may comprise aluminum, nickel, copper, titanium, stainless steel, iron, or the like or a combination comprising at least one of the foregoing.

The separator 300 secures a flow path between the plurality of stacked electrodes, and blocks electrical contact between the electrodes and between the current collectors. The separator 300 may include, for example, an acrylic fiber, a polyethylene film, a polyprophylene film, or the like or a combination comprising at least one of the foregoing.

The operation and effects of the first capacitive deionization device 10 are described in further detail below.

First, a process of softening hard water (also referred to as a charging process) may be performed as follows.

While the power supply PS applies a direct current (“DC”) voltage to the electrodes, hard water flows into the stack of the first capacitive deionization device 10 via the inlet 11. In an embodiment, the electrode 100, which is electrically connected to a positive terminal of the power supplier PS, is polarized with a positive voltage and the electrode 100, which is electrically connected to a negative terminal of the power supplier PS, is polarized with a negative voltage. Referring to FIG. 1, the electrode 100, which is polarized with a positive voltage, and another electrode 100, which is polarized with a negative voltage face each other, wherein the separator 300 is disposed therebetween. Accordingly, cations, including hard water components, including Ca²⁺, Mg²⁺, or the like, which are included in the inflow hard water, are absorbed into the electrode 100, which is polarized with a negative voltage, and anions including Cl⁻, or the like, including harmful anions, are absorbed into the electrode 100, which is polarized with a positive voltage. As a processing time passes, the cations or anions, which are dissolved in the hard water, are absorbed and accumulate in the electrode 100. Accordingly, the hard water, which passes through the stack, is softened and turns into soft water. Moreover, the harmful ions included in the hard water are removed. However, as more processing time passes, a surface of the active material included in the electrode 100 may be covered with the absorbed cations and anions, and thus a softening efficiency of the capacitive deionization device may slowly deteriorate. The softening efficiency may be determined by measuring ionic conductivity of soft water flowing out from the outlet 12, or in an embodiment, the softening efficiency may be determined by measuring ionic conductivity of soft water flowing out from the outlet 12 over a selected period of time. In other words, when the ionic conductivity of the soft water is low, the amount of removed cations and anions may be large, and thus the softening efficiency may be high. Alternatively, when the ionic conductivity of the soft water is high, the amount of the removed cations and anions may be small, and thus the softening efficiency may be low.

When the ionic conductivity of the soft water is equal to or greater than a selected value, it may be desirable to regenerate the electrode 100. Thus, in an embodiment, when power supplied to the first capacitive deionization device 10 is stopped and the first capacitive deionization device 10 is electrically shorted so as to discharge the first capacitive deionization device 10, the electrode 100 may lose polarity, and thus the ions absorbed into the active material of the electrode 100 may be desorbed. Accordingly, an active surface of the active material of the electrode 100 may be restored. In an embodiment, not all the ions absorbed into the surface of the active material are desorbed, since the absorbed ions, specifically cations, such as Ca²⁺, Mg²⁺, or the like, react with anions to form a scale. In an embodiment, the scale may comprise a CaSO₄. Since the CaSO₄ may have a dentritic structure, a ratio describing coverage of the active surface area of the active material per unit weight CaSO₄ may be low and accessibility of the hard water to the active material may be improved, and thus even when a charging and discharging cycle is repeated, a rate of active surface area reduction may be reduced. Consequently, durability of the electrode 100 is improved, as described in further detail below.

FIG. 2 is a perspective view schematically illustrating a second capacitive deionization device 20 including an electrode 100, according to another embodiment. The second capacitive deionization device 20 of FIG. 2 may be a flow-though type water softener.

Referring to FIG. 2, the second capacitive deionization device 20 according to an embodiment includes an electrode 100, a current collector 200 and a separator 300. Electrodes may be disposed on both sides of the current collector 200, and combinations of electrodes and current collectors may be stacked in a plurality of layers to form a stack, wherein a separator 300 is disposed between the combinations. In an embodiment, the electrode 100 may be disposed only on one side of the current collector 200.

The second capacitive deionization device 20 is different from the first capacitive deionization device 10 in that a flow path of hard water of the second capacitive deionization device 20 is a flow-though type path, instead of a serpentine type path. Thus the first capacitive deionization device 10 and the second capacitive deionization devices 20 have different flow paths, and the arrangement of elements in the two devices are different.

Detailed structures, materials, and functions of each element included in the second capacitive deionization device 20, and operation and effects of the second capacitive deionization device 20 are substantially identical to those described with reference to the first capacitive deionization device 10 of FIG. 1, and thus further details thereof are not repeated.

FIG. 3 is a cross-sectional view schematically illustrating an embodiment of an electric double layer capacitor 30 including an embodiment of an electrode 100. The electric double layer capacitor 30 may store electricity.

Referring to FIG. 3, the electric double layer capacitor 30, according to an embodiment, includes an electrode 100, a current collector 200, a separator 300 a gasket 400 and an electrolyte 500.

In detail, the current collectors are spaced apart from and face each other, wherein the separator 300 is disposed between the current collectors, each electrode 100 is disposed on a side of the current collector facing the separator 300, respectively, an electrolyte is disposed in a space between each electrode 100 and the separator 300, and the gasket 400 may reduce or effectively prevent the electrolyte from flowing out of the space by sealing sides of the space.

The electrolyte may include an aqueous electrolyte in which a salt is dissolved, and may include a sodium chloride aqueous solution, a magnesium sulfate aqueous solution, a magnesium calcium aqueous solution, or the like or a mixture including at least one of the foregoing.

Operation and effects of the electric double layer capacitor 30 are described in further detail below.

First, when a DC voltage is applied to the electrodes, anions of the electrolyte are electrostatically induced to move to the electrode 100 polarized with a positive voltage, and cations of the electrolyte are electrostatically induced to move to the electrode 100 polarized with a negative voltage. Accordingly, in a charging process, the anions and the cations are absorbed into the active material of the electrodes, and thus an electric double layer is formed on an interface of the electrode 100 and the electrolyte. Such a process is called charging. When the charging is completed, current does not substantially flow in the electric double layer capacitor 30. When a circuit (not shown) including a load (not shown) is disposed on the electrodes 100 after the charging, electrical energy of the electric double layer is slowly reduced. Such a process is called discharging.

During discharging, the electrodes 100 slowly lose polarity, and thus the ions absorbed in the active material of the electrode 100 are desorbed. Accordingly, the active surface of the active material of the electrode 100 is restored.

The following examples are included for illustrative purposes only and are not intended to limit the scope of the invention.

### EXAMPLES

### Example 1

### Manufacturing an Electrode and a Cell

1) Preparation of Polytetrafluoroethylene (“PTFE”) Suspension of 5 wt %

A PTFE suspension of 5 wt % was prepared by adding propylene glycol to a PTFE aqueous suspension of 60 wt %.

2) Preparation of an Electrode

After putting ketjen black (EC300J of Mitsubishi) as an active material in a stirring vessel, the PTFE suspension prepared as above was added to the stirring vessel in such a way that the amount of the PTFE suspension was 5 wt %. The mixture was kneaded and pressed so as to obtain an electrode.

3) Drying

The electrode was dried in an oven for 2 hours at 80° C., 1 hour at 120° C., and 1 hour at 200° C.

4) Preparation of a Cell

\textcircled{1} The electrode dried as above was cut to prepare 2 pieces, each having an area of 10 centimeters (“cm”)×10 cm (100 square centimeters (“cm²”)), and a weight of each piece was measured.

\textcircled{2} The two pieces of electrodes were put into distilled water and were vacuum-impregnated.

\textcircled{3} A cell was prepared by sequentially stacking a current collector (graphite foil), one piece of the electrodes in \textcircled{2}, a separator (acrylic fiber: manufactured by Assai), another piece of the electrodes in \textcircled{2}, and the current collector (graphite foil).

\textcircled{4} Pressure applied to the cell was adjusted by using a torque wrench, and the torque was increased to 3 neuton-meters (“N-m”).

### Comparative Example 1

Electrodes and a cell were prepared in the same manner as in Example 1, except that 0.9 grams (“g”) of activated carbon (MSP-20 of Kansai Thermochemistry Co., Ltd) was used as an active material instead of 1 g of ketjen black, and 0.1 g of carbon black (Super P) was additionally used as a conductive agent.

### Comparative Example 2

Electrodes and a cell were prepared in the same manner as in Example 1, except that 0.9 g of activated carbon (PC of Osaka Gas) was used as an active material instead of 1 g of ketjen black, and 0.1 g of carbon black (Super P) was additionally used as a conductive agent.

### Comparative Example 3

Electrodes and a cell were prepared in the same manner as in Example 1, except that carbon black (Black Pearl 2000 of Cabot) was used as an active material instead of ketjen black.

### Comparative Example 4

Electrodes and a cell were prepared in the same manner as in Example 1, except that carbon black (Vulcan XC72 of Cabot) was used as an active material instead of ketjen black.

Properties of the active materials used in Example 1 and Comparative Examples 1 through 4 are shown in Table 1 below.

TABLE 1

| | | Specific | | Amount | Amount | |
|---|---|---|---|---|---|---|
| | Type of | Surface | Pore | of | of | O/C |
| | Active | Area | Volume | Oxygen | Carbon | Atomic |
| Examples | Material | (m²/g) | (cm³/g) | (wt %) | (wt %) | Ratio |
| Example 1 | Ketjen | 800 | 1.15 | 0.77 | 99.23 | 0.78 |
| | Black | | | | | |
| | EC 300J | | | | | |
| Comparative | MSP-20 | 2200 | 0.96 | 5.78 | 94.22 | 6.13 |
| Example 1 | | | | | | |
| Comparative | PC | 1800 | 1.04 | 4.49 | 95.51 | 4.70 |
| Example 2 | | | | | | |
| Comparative | Black | 1500 | 4.50 | 1.32 | 98.68 | 1.34 |
| Example 3 | Pearls | | | | | |
| | 2000 | | | | | |
| Comparative | Vulcan | 250 | 0.63 | 0.90 | 99.10 | 1.2 |
| Example 4 | XC72 | | | | | |

* cm³/g refers to cubic centimeters per gram

In Table 1, specific surface areas and pore volumes of the active materials were measured by the Brunauer-Emmett-Teller (“BET”) method (Micrometrics, Tristar3000). Also, amounts of oxygen and amounts of carbon were measured by X-ray photoelectron spectroscopy (“XPS”) (Physical Electronics, Quantum 2000).

### EVALUATION EXAMPLES

### Evaluation Example 1

### Evaluation of Durability of Cell Electrode

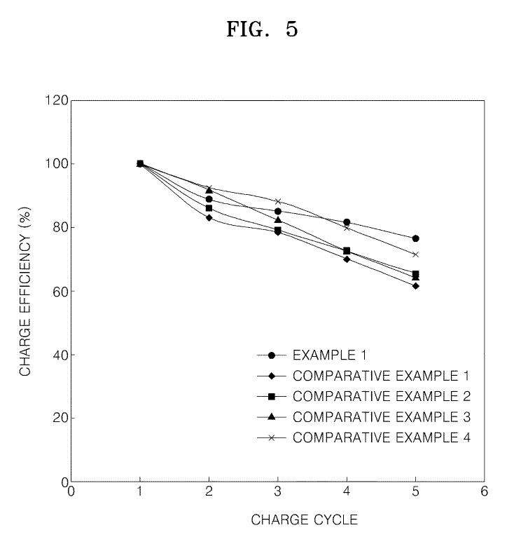

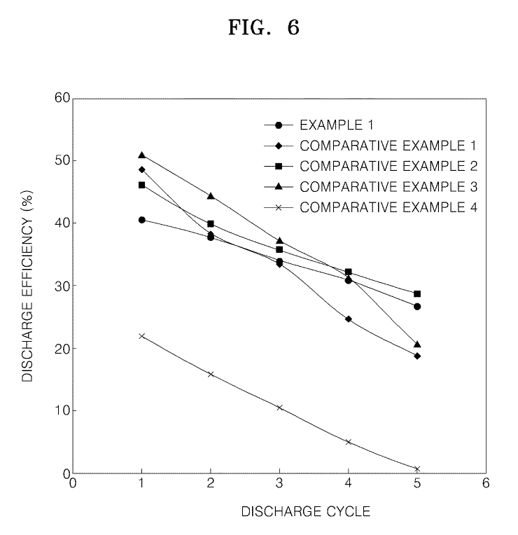

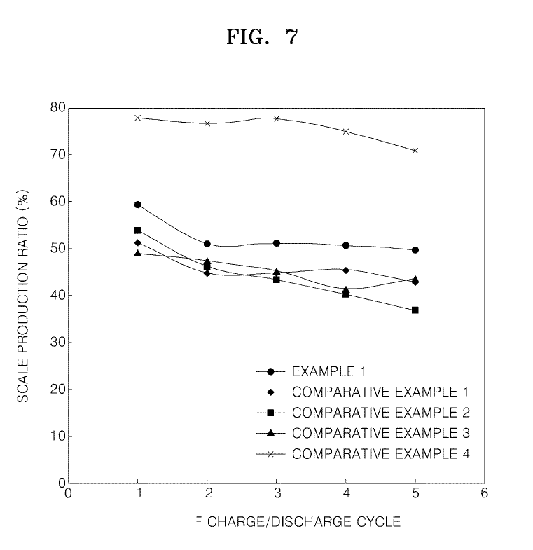

The cells prepared in Example 1 and Comparative Examples 1 through 4 were each operated under the following conditions, and charging efficiency, discharging efficiency, and a scale production rate corresponding to a number of charging and discharging cycles were measured. The results of these measurements are respectively shown in FIGS. 5 through 7.

\textcircled{1} Each cell was operated at room temperature, such as “about 20° C., while an electrolyte was sufficiently supplied to the cell.

\textcircled{2} Hard water (IEC 60734) was used as the electrolyte, and the volumetric flow rate of the hard water was adjusted to 80 milliliters per minute (“mL/min”).

\textcircled{3} Each cell was charged with a static voltage (3.5 V) for 10 minutes (“min.”), and then discharged for 15 min. by electrically shorting the cell.

The charging efficiency may be calculated using Equation 1 below.

Charging Efficiency(percent, “%”)=(charge area during an n^{th} charging after an n−1^{th} charging and discharging)/(charge area during the first charging) (Equation 1)

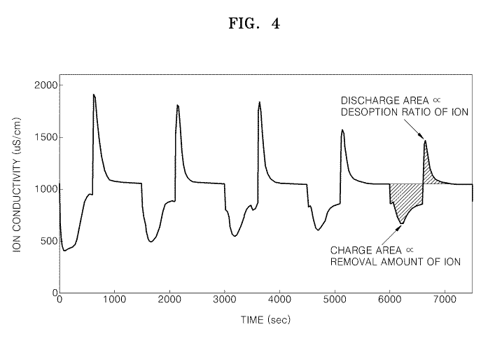

In Equation 1, n is a natural number that is equal to or greater than about 1, and the charge area is a value calculated using Equation 2 below, and is also shown in FIG. 4. The charge area is in proportion to the amount of ions in an electrolyte removed by a cell.

Charge area=(ionic conductivity of electrolyte measured before passing through cell×charging time)−(region obtained by integrating ionic conductivity curve of electrolyte according to time during actual charging time interval) (Equation 2)

The discharging efficiency may be calculated using Equation 3 below.

Discharging Efficiency(%)=(discharge area during an n^{th} discharging after an n−1^{th} charging and discharging)/(charge area during n^{th} charging after an n−1^{th} charging and discharging) (Equation 3)

In Equation 3, n is a natural number that is equal to or greater than about 1, and the discharge area is calculated using Equation 4 below, and is also shown in FIG. 4. The discharge area is in proportion to the desorption ratio of ions from an electrode.

Discharge area=(region obtained by integrating ionic conductivity curve of electrolyte according to time during actual discharging time interval)−(ionic conductivity of electrolyte measured before passing through cell×discharging time) (4)

The scale production rate may be calculated using Equation 5 below.

Scale Production Rate(%)=Charging Efficiency(%)−Discharging Efficiency(%) (5)

Referring to FIGS. 5 through 7, as the number of charging and discharging cycles increases in Example 1 and Comparative Examples 1 through 4, the charging efficiency, the discharging efficiency and the scale production rate generally decreased. However, the rate of decrease of the charging efficiency in Example 1 was lower than that in Comparative Examples 1 through 4, and thus durability of the electrode of Example 1 was improved. In order to more closely examine reasons for such a durability characteristic, a type of a scale formed in an electrode was analyzed by using XRD and EDS, and a shape of the scale was examined by using a scanning electron microscope (“SEM”).

### Evaluation Example 2

### Analysis on Type of Scale Formed on Cell Electrode

A scale formed on an electrode was analyzed by using XRD (RINT2501V of Rigaku) and SEM/EDS (S4500 of Hitachi), after charging and discharging the electrode 5 times, and it was observed that a scale formed in Example 1 mainly included CaSO₄, and scales formed in Comparative Examples 1 through 4 mainly included CaCO₃. Operating conditions of XRD and EDS were as follows.

XRD: Operating Temperature=10° C. to 90° C., Scan Rate=1° C./min.

SEM/EDS: Observation after Au coating.

### Evaluation Example 3

### Analysis of Shape of Scale Formed on a Cell Electrode

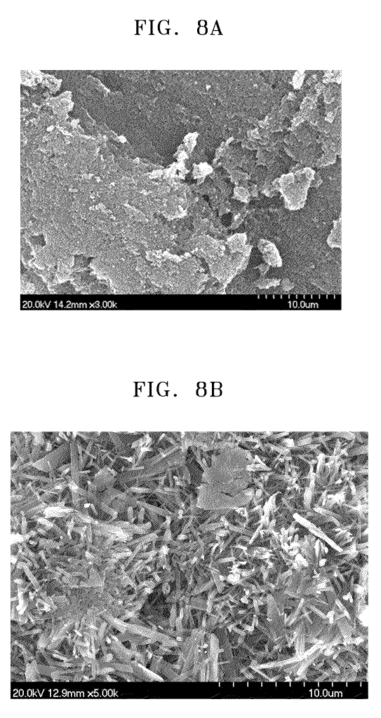

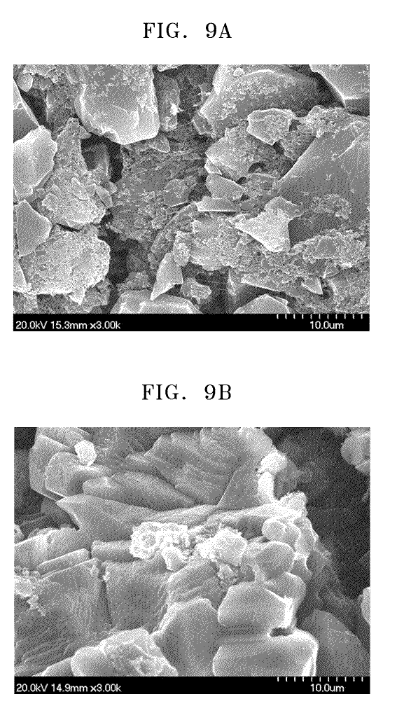

A scale formed on an electrode was photographed by using a SEM, after charging and discharging the electrode 5 times, and it was found that a scale (CaSO₄) formed in Example 1 had a dentritic structure as illustrated in FIG. 8B, and a scale (CaCO₃) formed in Comparative Example 1 had an irregular structure covering a surface of the active material as illustrated in FIG. 9B. FIGS. 8A and 9A are SEM photographic images of a surface of an electrode, i.e. a surface of the active material before charging and discharging, respectively.

Referring to Evaluation Examples 1 through 3 above, since the cell prepared in Example 1 formed a scale that mainly included CaSO₄ having a dentritic structure, a fraction of a surface area of the electrode covered by the scale was small, and thus charging efficiency was high even when the scale production rate was high. However, since the cells prepared in Comparative Examples 1 through 4 formed a scale that mainly included CaCO₃ having an irregular structure, a fraction of a surface area of the electrode covered by the scale was very large, and thus charging efficiency was low even when the scale production rate was low.

Durability of the cells prepared in Example 1 and Comparative Examples 1 through 4 and types of scales formed in the corresponding electrodes are shown in Table 2 below. Here, durability of a cell denotes a charging rate measured during the 5^{th} charging cycle after the 4^{th} charging and discharging cycles.

TABLE 2

| | Durability (%) | Scale |
|---|---|---|
| Example 1 | 77 | CaSO₄ |
| Comparative Example 1 | 62 | CaCO₃ |
| Comparative Example 2 | 66 | CaCO₃ |
| Comparative Example 3 | 64 | CaCO₃ |
| Comparative Example 4 | 72 | CaCO₃ |

It should be understood that the exemplary embodiments described herein should be considered in a descriptive sense only and not for purposes of limitation. Descriptions of features or aspects within each embodiment should typically be considered as available for other similar features or aspects in other embodiments.

What is claimed is:

1. An electrode for capacitive deionization, the electrode comprising an active material having an oxygen to carbon atomic ratio between about 0.1 and about 1 and a specific surface area between about 500 square meters per gram and about 3,000 square meters per gram.

2. The electrode of claim 1, wherein the active material comprises an oxygen containing functional group, the oxygen containing functional group comprising a group selected from the group consisting of a phenol group, a phenoxy group, a lactone group, a carboxyl group, a carbonate group, a carbonyl group and a combination comprising at least one of the foregoing groups.

3. The electrode of claim 1, wherein the active material comprises carbon black.

4. The electrode of claim 3, wherein the carbon black comprises ketjen black.

5. The electrode of claim 1, wherein the amount of the active material is between about 70 weight percent and about 98 weight percent of a total weight of the electrode.

6. The electrode of claim 1, further comprising CaSO₄ formed on the electrode.

7. A capacitive deionization device comprising the electrode of claim 1.

8. An electrode for an electric double layer capacitor, the electrode comprising an active material having an oxygen to carbon atomic ratio between about 0.1 and about 1 and a specific surface area between about 500 square meters per gram and about 3,000 square meters per gram.

9. An electric double layer capacitor comprising the electrode of claim 8.

10. The electrode of claim 1, further comprising calcium or magnesium.

11. A water softener, comprising:
an electrode comprising an active material having an oxygen to carbon atomic ratio between about 0.1 and about 1 and a specific surface area between about 500 square meters per gram and about 3,000 square meters per gram.

12. The water softener of claim 10, further comprising a serpentine type flow path.

13. The water softener of claim 10, further comprising a flow-through type flow path.
